(19) United States
(12) Patent Application Publication
(10) Pub. No.: US 2020/0318990 A1
(43) Pub. Date: Oct. 8, 2020

(54) Method of Producing and Using a Transit-time map

(71) Applicant: Fluency, Inc., Burlington, VT (US)

(72) Inventors: Eric Mayhew, Bristol, VT (US); Michael Lane, Burlington, VT (US); Scott Gale, Williston, VT (US); Brian McVey, Burlington, VT (US)

(21) Appl. No.: 16/816,567

(22) Filed: Mar. 12, 2020

Related U.S. Application Data
(60) Provisional application No. 62/828,987, filed on Apr. 3, 2019.

(51) Int. Cl. G01C 21/36; G01C 21/16

(52) U.S. Cl. CPC G01C 21/3673; G01C 21/16; G01C 21/3682; G01C 21/3676

(57) ABSTRACT

A method of producing a transit-time map uses a digital mapping service, a digital transit-time mapping program, and a connected digital device. A user-defined initial location, a pre-defined transit-time, and a user-chosen travel mode are input into the digital transit-time mapping program, Running the digital transit-time mapping program includes repeatedly accessing the digital mapping service to determine a locus of points on the digital spatial map. The time to travel from the user-defined initial location to each point of the locus of points is substantially equal to the pre-defined transit time for the user-chosen travel mode. The points of the locus of points on the digital spatial map are stored.

### FIELD

This patent application generally relates to techniques for mapping. More particularly, it is related to techniques for producing and using a map based on time of travel.

### BACKGROUND

Maps have traditionally shown the relationship of locations based on distance. Improvement is needed in map making to show the relationship of locations based on time, and this improvement is provided in the current patent application.

### SUMMARY

One aspect of the present patent application is a method of producing a transit-time map. The method uses a digital mapping service, a digital transit-time mapping program, and a connected digital device. A user-defined initial location, a pre-defined transit-time, and a user-chosen travel mode are input into the digital transit-time mapping program. Running the digital transit-time mapping program includes repeatedly accessing the digital mapping service to determine a locus of points on the digital spatial map. The time to travel from the user-defined initial location to each point of the locus of points is substantially equal to the pre-defined transit time for the user-chosen travel mode. The points of the locus of points on the digital spatial map are stored.

In one embodiment the pre-defined transit time is user-defined. In another, the pre-defined transit time is program-defined.

In one embodiment, the user-defined initial location is determined from a GPS receiver on the connected digital device.

One embodiment further comprises deriving a boundary on the digital spatial map from the locus of points. This embodiment may further include identifying an entity located within the boundary and audibly announcing a feature of the entity and/or displaying a feature of the entity. It may further include displaying the digital spatial map and the boundary on the digital spatial map on a display. The boundary may be derived by connecting the points of the locus of points. The boundary may be derived by connecting points of a plurality of previously defined areas through which the locus of points extends. This previously defined areas may include a postal code area, a political district area, and/or a school district area. The boundary on the digital spatial map has a first side and a second side, and the method may further include communicating information to a plurality of digital devices physically located on the first side while avoiding communicating the information to a plurality of digital devices physically located on the second side. The information may include at least one from the group consisting of text, image, video, audio, and fax. A method may further include searching for an entity within the boundary. It can further include looking up a parameter of the entity on a website of the entity. The parameter may include a fact about the entity, a rating of the entity, and/or a non-travel-related delay time for receiving service at the entity. The non-travel related delay time for receiving service at the entity may include hours the entity is open, an availability time during hours the entity is open, and/or a time for performing the service at the entity.

In one embodiment, the digital transit-time mapping program is included in the digital mapping service.

In one embodiment, the digital transit-time mapping program accesses the digital mapping service through an application program interface (API). In this embodiment the digital mapping service may be publically accessible on the internet, and the method further includes accessing the digital mapping service through the internet.

In one embodiment, the travel mode includes walking, biking, automobile, public transit, air travel, drone travel, elevator travel, and/or sub-ground level travel.

In one embodiment, the method further includes a second user-chosen travel mode. The second user-chosen travel mode follows the user-chosen travel mode. The calculating the locus of points includes both the time to travel for the user-chosen travel mode and time to travel for the second travel mode.

In one embodiment, in the digital mapping service, a speed used for calculating the time to travel is an average speed or a typical speed.

In one embodiment, in the digital mapping service, a speed used for calculating time to travel is an actual speed as measured in real time.

In one embodiment, the locus of points extends 360 degrees around the user-defined location.

In one embodiment, the repeatedly accessing the digital mapping service to determine the locus of points includes providing a plurality of points in a plurality of directions from the user-defined location. Each of the plurality of points has a tentative distance from the user-defined location. The method includes recording time to travel from the user-defined location to the tentative distance along each of the plurality of directions, as computed by the digital mapping service program and comparing the user-defined transit time with the computed time to travel for each of the plurality of directions. If the computed time to travel in one of the directions is different from the user-defined transit time by an amount that is greater than a pre-specified amount, adjusting the tentative distance along that direction and repeating computing time to travel from the user-defined location to the now-adjusted tentative distance along that direction. The comparing, computing, recording, and adjusting steps for the plurality of directions are repeated until the recorded time to travel in each of the directions is within the pre-specified amount of the user-defined transit time, wherein the tentative distance so obtained for each of the plurality of directions defines the locus of points.

In one embodiment, the adjusting of the tentative distance in a direction includes operating on the tentative distance with an algorithm that increases or decreases the tentative distance. In this embodiment the algorithm may increase or decrease the tentative distance proportional to the ratio of the calculated transit time to the user-defined transit time. At each the repeated access of the digital mapping service the algorithm may adjust the tentative distance by an amount equal to half the previous adjustment.

### BRIEF DESCRIPTION OF THE DRAWINGS

The foregoing and other aspects and advantages of the invention will be apparent from the following detailed description as illustrated in the accompanying drawings, in which:

FIG. 1A shows a user-defined initial location on an area map;

FIG. 1B shows a locus of points that can be reached within user-defined transit time Tᵤ from the user-defined initial location using a user-chosen travel mode;

FIG. 1C shows a boundary derived from the locus of points in which the boundary was formed by connecting the points of the locus of points of FIG. 1B, and the area within the boundary includes points that can be reached in less time than the user-defined transit time Tᵤ using the user-chosen travel mode, and the area outside the boundary includes points that require more time to reach than the user-defined transit time Tᵤ using the user-chosen travel mode;

FIG. 2 is a block diagram of the components that may be used for running the transit-time map creating program and computing and creating the transit-time map of FIGS. 1B and 1C;

FIG. 3A shows a smart phone, which is one of the components of FIG. 2, that enables a user to access the transit-time map creating program through an app stored in memory on the phone;

FIG. 3B shows the smart phone of FIG. 3A with a data entry device in which the user can select the user-defined transit time from a pre-selected list or in which the user can enter the user-defined transit time;

FIG. 3C shows the smart phone of FIG. 3A with a data entry device in which the user can select the travel mode from a pre-selected list of travel modes;

FIG. 4 illustrates the transit-time map being used for communicating information to one or more information receiving connected digital devices, such as smart phones (shown as triangles), that are physically located within the transit-time map boundary while avoiding sending that information to other smart phones (shown as squares) that are physically located outside transit-time map boundary;

FIG. 5A shows a postal code map with lines indicating boundaries of each postal code;

FIG. 5B shows the transit-time map boundary derived from the locus of points in which lines indicating outer reaches of each postal code of the postal code map form the boundary and the points of the locus of points are located within that boundary;

FIG. 6 shows a method of searching for one or more entities located within the transit-time map boundary with search terms, thus allowing a user to search for a specified type of entity within a specified transit time of her present location;

FIG. 7 shows the smart phone of FIG. 3A in which the user can select the entity parameter from a pre-selected list of entity parameters, or the user can enter a user defined search parameter;

FIG. 8 shows a transit time map in which the program provided several calculated transit time boundaries, one for each of several user-defined transit times Tᵤ; and

FIG. 9 is a flow chart of the method of the transit-time map creating program.

### DETAILED DESCRIPTION

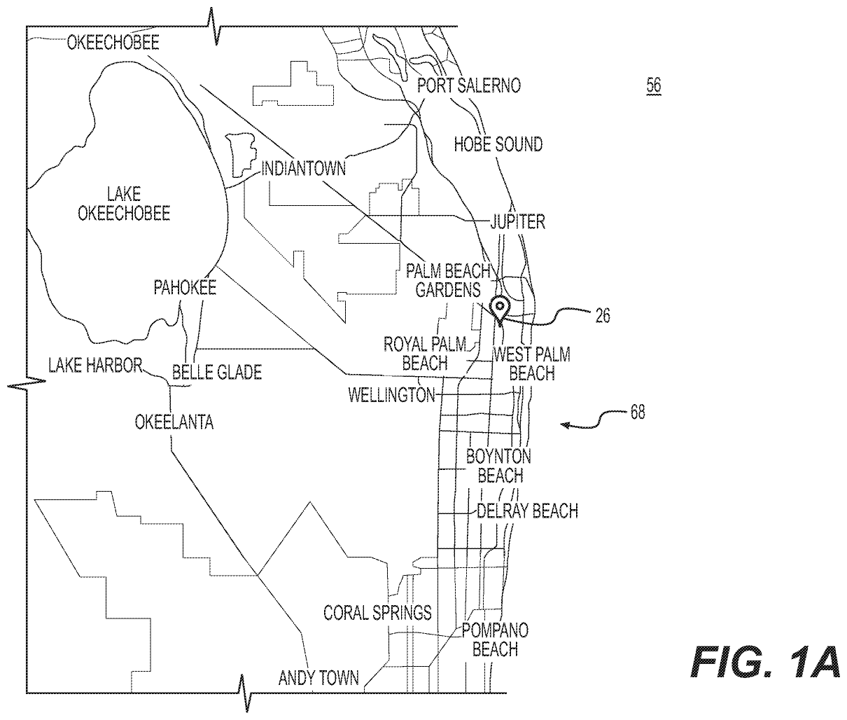

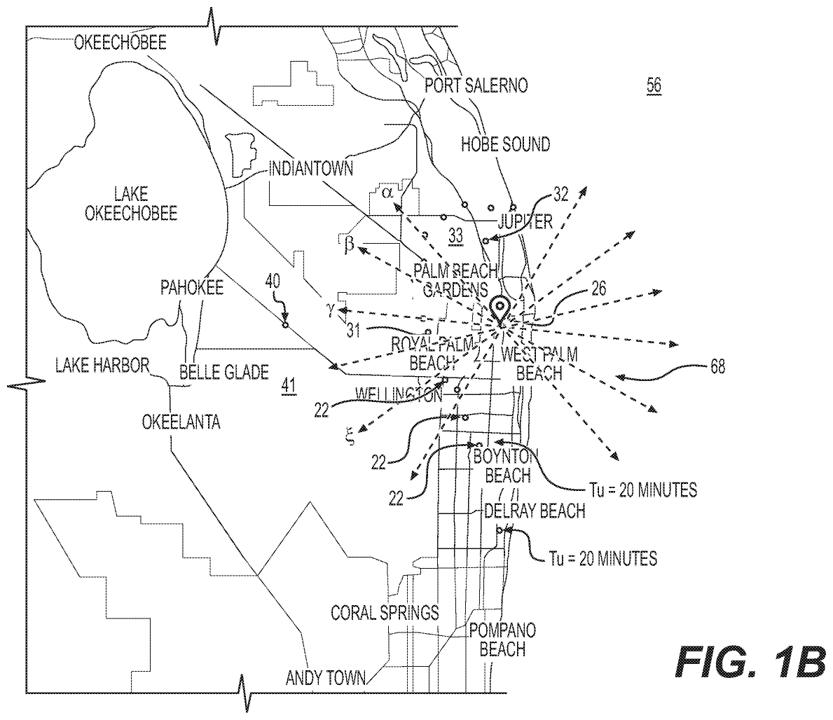

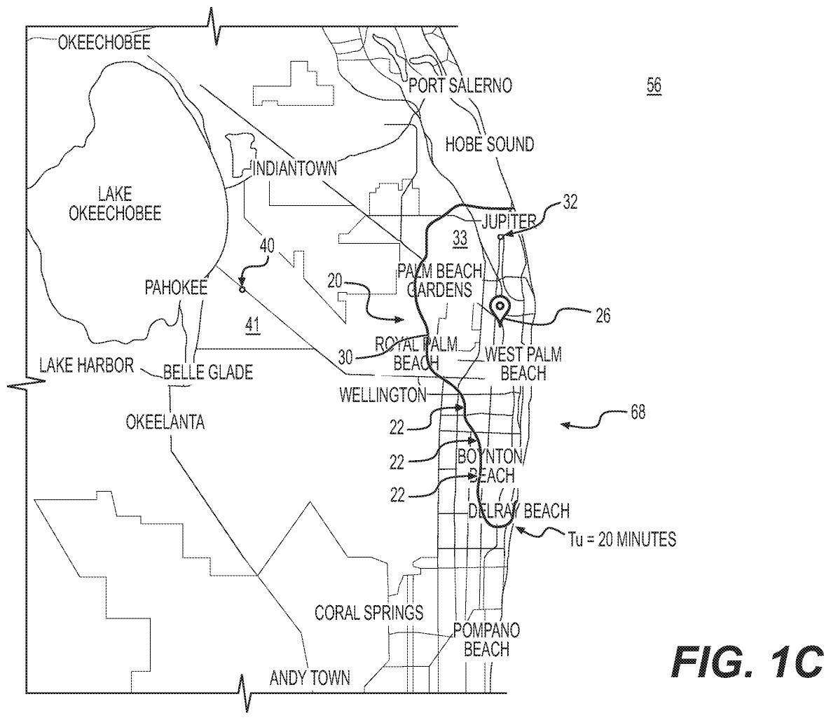

This application is related to techniques for producing and using a map in which all locations on the map within a given time of travel are shown. Travel-time map 20 includes locus of points 22 that can be reached within user-defined transit time Tᵤ from user-defined initial location 26 using user-chosen travel mode 28, as shown in FIGS. 1a-1b. The present patent application provides methods of producing travel-time map 20 and methods of using travel-time map 20.

Transit-time map boundary 30 is derived from locus of points 22 determined from calculations for travel in a plurality of directions α, β, γ, . . . ξ from user-defined initial location 26. In one embodiment, transit-time map boundary 30 simply connects points 31 of locus of points 22, as shown in FIG. 1c. Transit-time map 20 also includes points 32 in area 33 within locus of points 22 and/or within transit-time map boundary 30 that generally are accessible from user-defined initial location 26 in a time approximately equal to or less than user-defined transit time Tᵤ using user-chosen travel mode 28. Transit-time map 20 may also include points 40 and area 41 outside transit-time map boundary 30 that are generally accessible from user-defined initial location 26 in more time than user-defined transit time Tᵤ using user-chosen travel mode 28.

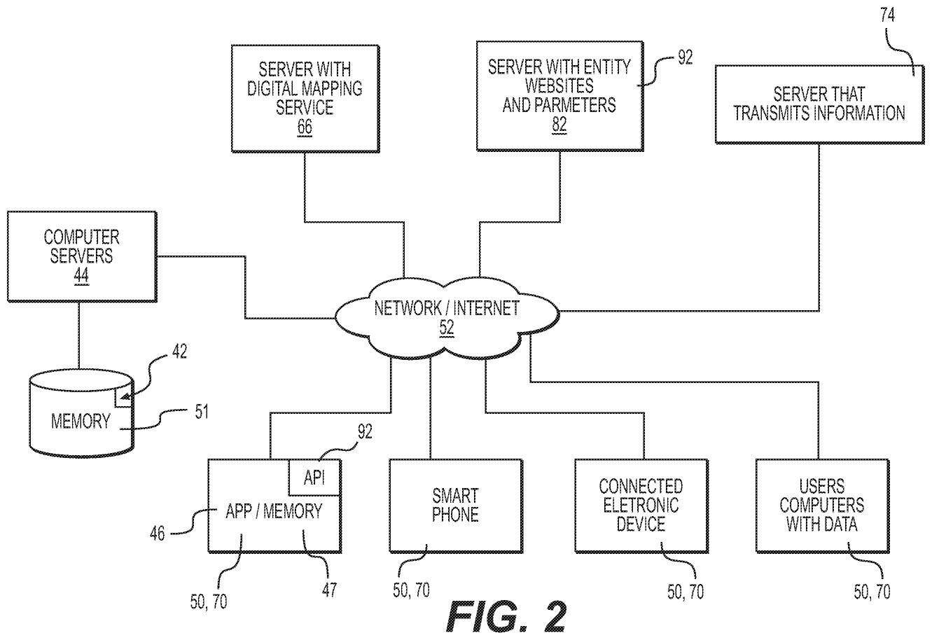

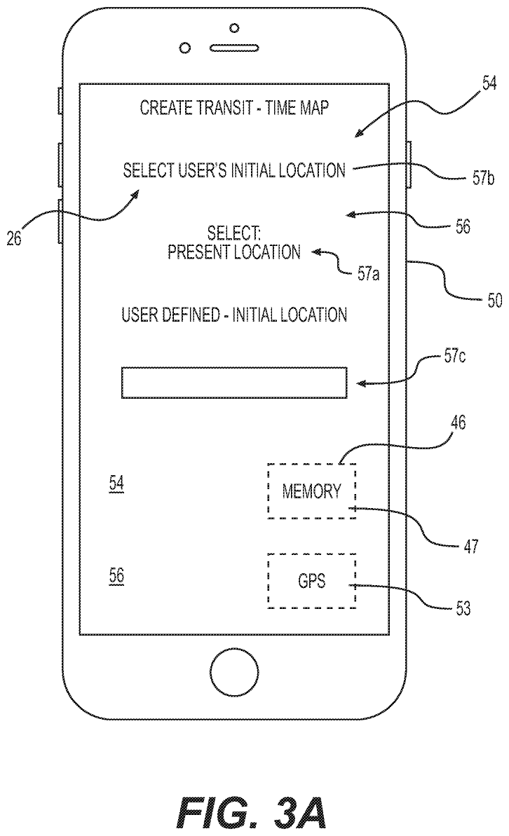

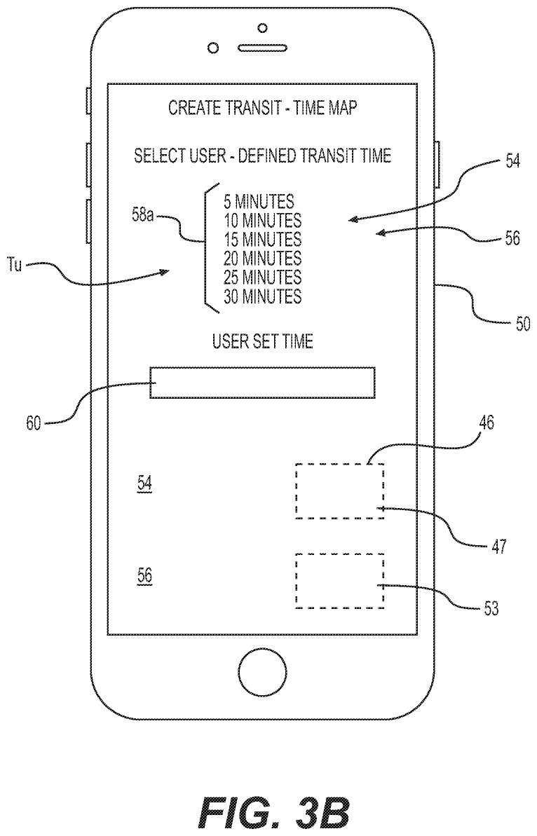

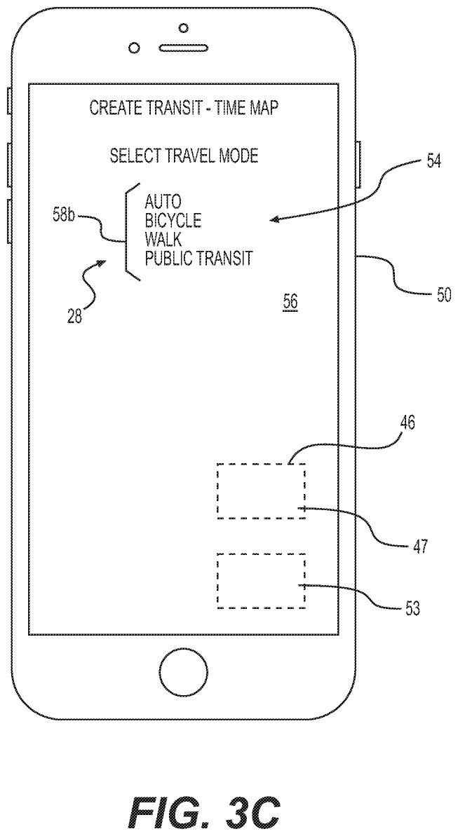

In one embodiment, the method includes running transit-time map creating program 42 for computing and creating transit-time map 20 that runs on computer server 44, as shown in block diagram, FIG. 2. In the method, user-defined transit time Tᵤ, user-defined initial location 26, and user-chosen travel mode 28 are input into transit-time map creating program 42. Transit-time map creating program 42 may be accessed by the user through a connected digital device transit-time map application (app) 46 stored in memory 47 on app-running connected digital device 50, such as a smart phone, as shown in FIGS. 2 and 3a-3c. Transit-time map creating program 42 may also be stored in memory 47 of connected digital device 50 and run under smart phone transit-time map app 46.

Connected digital device 50, can also be such other digital devices as a laptop or a desktop personal computer, a tablet, a car navigation system, a digital watch, a voice activated virtual assistant or smart speaker, such as Seri, Google Home, or Alexa.

Alternatively, connected digital device transit-time map app 46 may access transit-time map creating program 42 stored on memory 51 which is part of, or connected to, internet-connected computer server 44. Access in this case is through each of connected digital device 50's and server 44's connections to the internet 52.

App 46 running on connected digital device 50 includes data entry device 54, such as screen 56, through which the user may select or enter user-defined transit time Tᵤ, user-chosen travel mode 28, and user-defined initial location 26. Connected digital device 50 may automatically obtain initial location 26 as the user's present location from its on-board GPS receiver 53 if the user clicks “select present location” 57a, as shown in FIG. 3a. Alternatively, the user can select from a list of initial locations by clicking “select user's initial location” 57b or enter a user-defined initial location in box 57c.

In one embodiment, selection of user-defined transit time Tᵤ is made from clicking on an entry in pre-selected list 58a of transit times, as shown in FIG. 3b on screen 56 of connected digital device 50. Alternatively to pre-selected list 58a, or in addition, the user may enter a desired transit time Tᵤ in entry box 60 of screen 56.

Selection of user-chosen travel mode 28 is made from pre-selected list 58b of travel modes, as shown in FIG. 3c.

In one embodiment, transit-time map creating program 42 accesses internet-based digital mapping service 66, such as Google Maps, Google Earth, Apple maps, Bing maps, Here, or MapQuest. Alternatively, digital mapping service 66 may be stored in internal memory of connected digital device 50 or in memory 51 of server 44, accessible through internet 42. Digital mapping service 66 both provides underlying area map 68, as shown in FIG. 1, and calculates transit time between two user-selected points on area map 68 for a user-specified travel mode 28.

In one embodiment, the calculation of travel time in digital mapping service 66 is based on average travel speed or typical travel speed for the specified travel mode 28. In another embodiment, using internet connection to sensors or GPS receivers for real-time information, the calculation of travel time in digital mapping service 66 is based on actual travel speed of vehicles, as reported at a particular moment of time for specified travel mode 28 in view of actual road conditions, weather, time of day, and other factors.

In any of the embodiments, transit-time map creating program 42 for computing and creating transit-time map 20 makes repeated use of digital mapping service 66, to compute and create transit-time map 20 based on user-defined initial location 26, user-defined transit time Tᵤ, and the user-chosen travel mode 28, as described herein below.

In one embodiment, internet-based digital mapping service 66 is enhanced to run more quickly by including transit-time map creating program 42 into internet-based digital mapping service 66. Thus, delay from repeated internet transmissions is avoided. Alternatively, a digital mapping service program is stored on cell phone 50 along with transit-time map creating program 42. Either way, faster communication between transit-time map creating program 42 and digital mapping service is achieved, and time for the repeated access used for calculating and creating transit-time map 20 is reduced.

In addition to displaying transit-time map 20 on display screen 56, as shown in FIG. 1, transit-time map 20 can also be printed, transmitted, and/or stored.

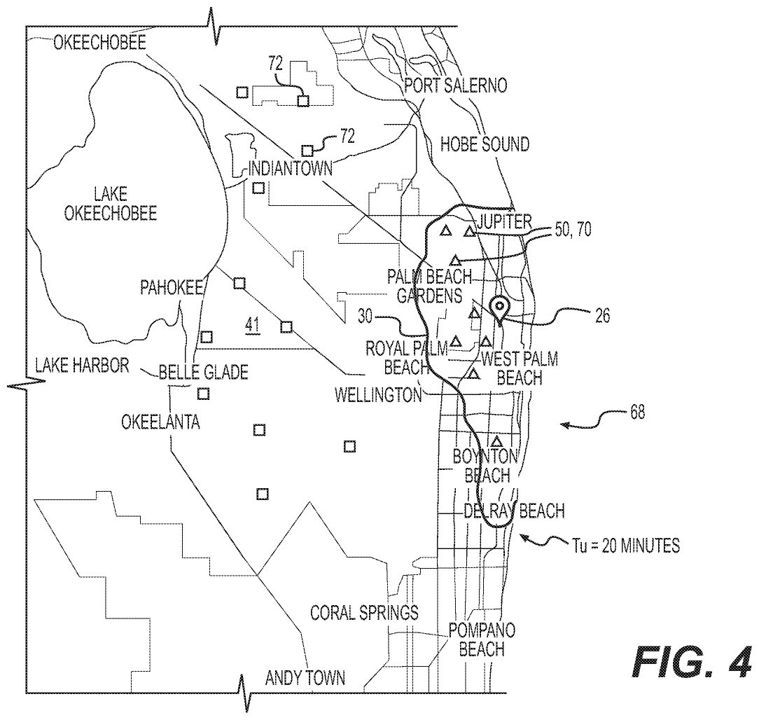

Transit-time map 20 so created may be used for communicating information to one or more information receiving connected digital devices, such as smart phones 70 (shown as triangles), that are physically located within transit-time map boundary 30 while avoiding sending that information to smart phones 72 (shown as squares) that are physically located outside transit-time map boundary 30, as shown in FIG. 4. The information may be communicated by server 74 that transmits information to connected digital devices 50, as shown in FIGS. 2 and 4, under limits set by boundary 30 of transit-time map 20. Server 74 that transmits information to connected digital devices may be a third party server, such as Facebook or Google.

Information directed to information receiving electronic devices 50, 70 within transit-time map boundary 30 may include text, image, video, audio, and/or fax. The information may be public interest, education, entertainment, scientific, business, advertising, or any other kind of information. In one example, the information is displayed on each connected digital device's Facebook or Google. In this example, the information on Facebook or Google is directed only to connected digital devices 50, 70 that are located within transit-time map boundary 30.

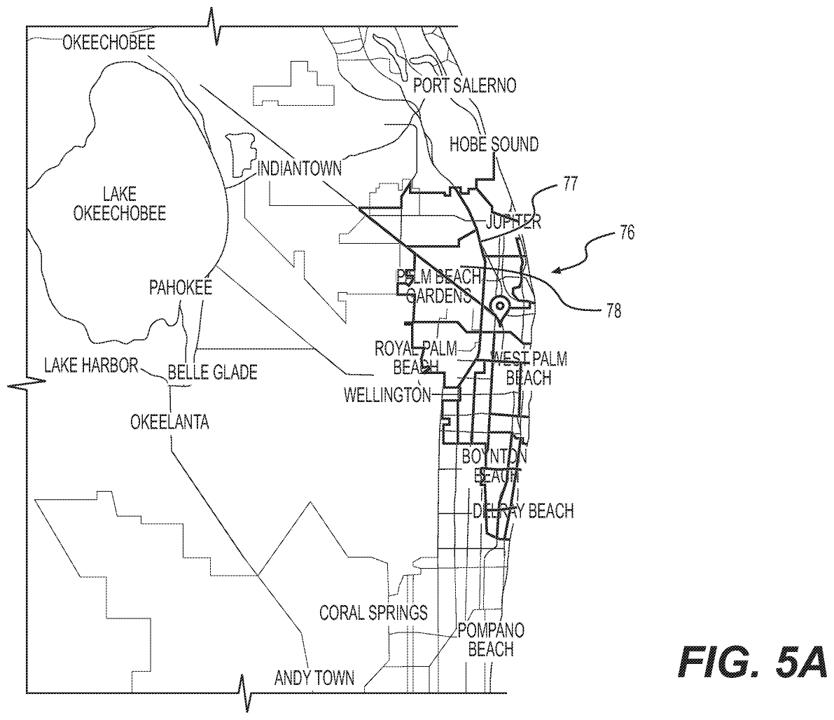

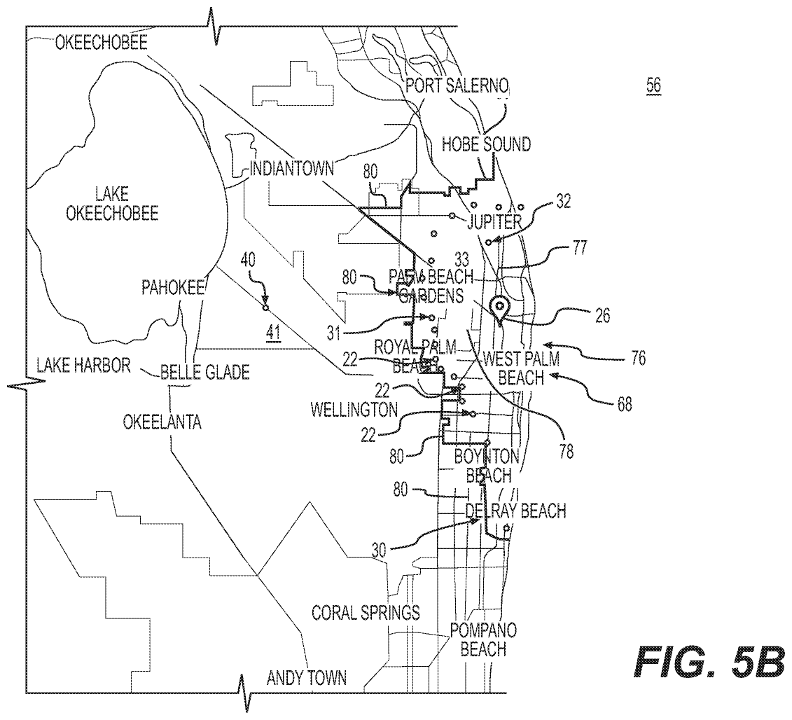

As an alternative to simply connecting points 32 of locus of points 22, transit-time map boundary 30 may otherwise be derived from locus of points 22. In one example, postal code map 76 is used, as shown in FIG. 5a. Lines 77 on postal code map 76 indicate boundaries of each postal code 78 of postal code map 76.

Transit-time map boundary 30 extends beyond locus of points 22 as it is determined by outer reaches 80 of postal codes 78 through which locus of points 22 extend, as shown in FIG. 5b. In one embodiment, locus of points 22 extends through certain postal codes 78, as shown in FIG. 5b. Transit-time map boundary 30 is derived, in this example, from outer reaches 80 of those postal codes 78 through which locus of points 22 extends.

In the postal code example shown in FIGS. 5a-5b, transit-time map boundary 30 so derived extends further out from the user-defined initial location than points 31 of locus of points 22. In other circumstances, such as if only those postal codes fully within locus of points 22 were to be included, inner reaches of postal codes 78 (not show) are used to derive transit-time map boundary 30 from locus of points 22. In this case derived transit-time map boundary 30 would lie fully within points 31 of locus of points 22. Alternatively, a criterion such as, if the centroid of the postal code is within the locus of points use a boundary of that postal code.

Alternatively to postal code lines, congressional district lines, city limit lines, county limit lines, state boundary lines, neighborhood lines, borough lines, or any other map boundary lines may be used.

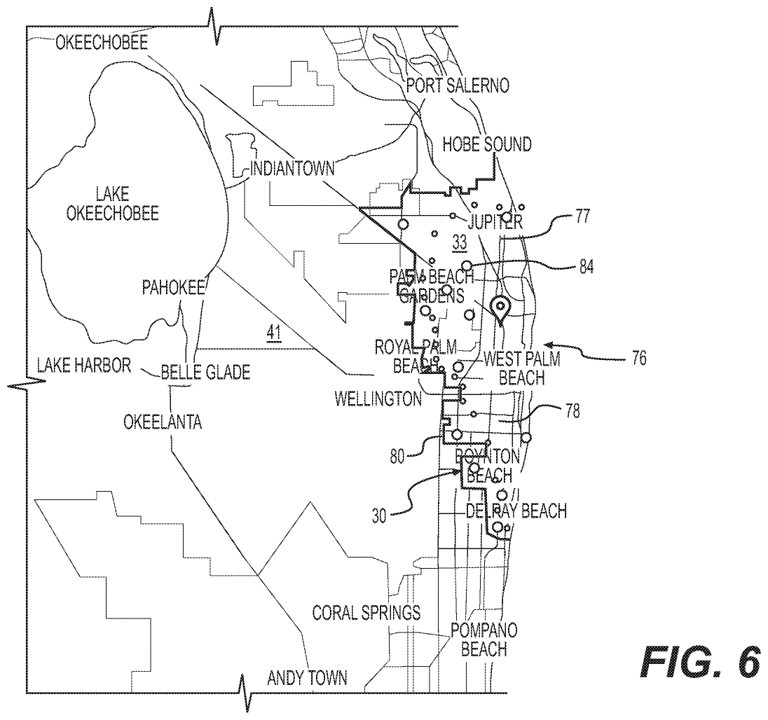

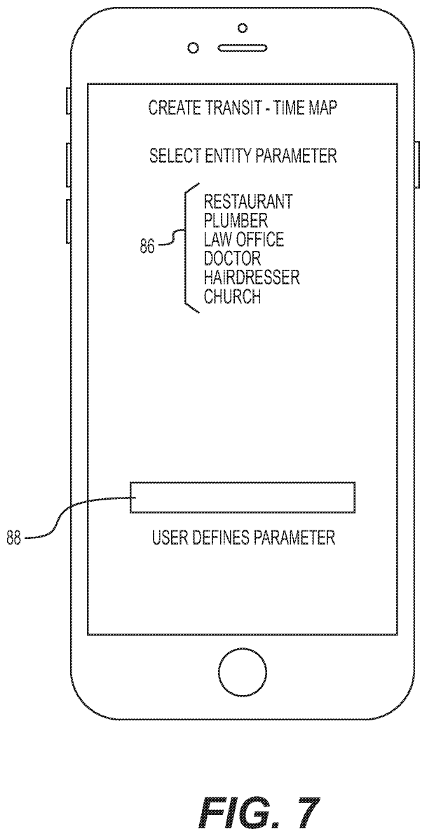

In one embodiment, the method further includes searching for one or more entities 84 located within transit-time map boundary 30 with search terms, as shown in FIG. 6. Thus, a user may search for an entity 84 within a 10 minute walk of her present location 26. The user selects parameter 86, such as a restaurant, coffee shop, a plumber, a legal office, a medical facility, a hairdresser, a clothing store, a music school, a church of a particular denomination, or an apartment for rent, as shown in FIG. 7. Alternatively, the user may enter user-defined search parameter 88. In one embodiment, transit-time map creating program 42 identifies only entities 84 having the user-selected or user-defined parameter 88 that are within transit-time map boundary 30. Thus, the user identifies entities 84 having user-defined parameter 88 that are located within user-defined transit time Tᵤ using user-chosen travel mode 28.

Alternatively, transit-time map creating program 42 can be used by entity 84 to filter its potential customers. For example, a plumber can use transit-time map creating program 42 for limiting customer calls to those who are within transit-time map boundary 30. In one example, on a winter day when many pipes are frozen, the plumber uses transit-time map creating program 42 to identify himself or herself with Facebook or Google notices only to potential customers who are located within a plumber-defined travel time from his or her business location or from his or her present location. This limitation may also be by way of allowing his or her website to be found in an internet search for plumbers only to those devices that are located within transit-time map boundary 30 produced by transit-time map creating program 42. That is, devices that are within a pre-set travel time of the plumber. Thus, the plumber can avoid notifying potential customers who are located outside his or her desired travel range, as shown by squares in FIG. 4, and so avoid receiving unwanted phone calls from such distant potential customers.

In one embodiment, the method is combined with looking up parameter 90 on the website of entity 84, which is found on server 92, as shown in FIG. 2. For example, entity parameter 90 may include the number of bedrooms in an apartment for rent, a rating of a restaurant, the cost of an appliance, or a non-travel-related delay time for service at an entity, such as the time for getting a table at the restaurant. Entity parameters 90 related to non-travel related delay time for service at entity 84 may, for example, include the hours entity 84 is open, the wait time to receive service in view of other customers, and the time needed to perform the service at entity 84 from the time the service begins. Thus, the looking up of one or more parameters 90 of entity 84 can narrow the search further than just the narrowing achieved by searching for entities 84 within transit-time map boundary 30.

Parameters 90 of entities 84, such as business hours, and menu, prices, are often found on the website of the entity 84. In one embodiment, transit-time map-creating program 42 includes software, known as an Application Program Interface (API) 92, that allows program 42 to communicate with such websites as well as with other programs, such as Google maps. Using such an API 92 with program 42 a user can select from a list of desired parameters 90 on the website of an entity 84. Program 42 can then display entities 84 that are both within a specied transit time and have the desired parameters 90. Alternatively, a user can input an entity parameter search term 88, as shown in FIG. 7.

In one application, the method is used to search for entities 84 whose websites provide values of such parameters 90. For example, parameters 90 that may be selected or entered into transit-time map creating program 42 on connected digital device 50 may including entity parameters restaurant, Mexican ethnicity, price range between $10 and $20, and no more than a delay of 15 minutes for availability of a table, with user-defined transit time Tᵤ of 20 minutes, for a user traveling by bicycle.

In another application, a landlord can use the method to reach out to all information-receiving smart phone devices 50, 70 (and to their device owners), that are located within 15 minute walk of a vacant condo. The method allows informing all such potential house-hunters that a condo located within a 15 minutes walk of their present location is available. If the potential house-hunter's present location happens to be her place of employment, the method provides such a house-hunter information about a condo located within a 15 minute walk of her workplace.

In one embodiment, the method includes selecting the first user-chosen travel mode from a group of available travel modes, wherein boundary 30 varies as a function of user-chosen travel mode 28. The user-chosen travel modes that may be available for selection on connected digital device 50 may include walking, biking, automobile, public transit, air travel, drone travel, elevator, and sub-ground level travel.

In one embodiment, the method further includes calculating the boundary for a journey that includes two or more travel modes, one after the other. For example, a first part of the journey is walking while a second part of the journey is by public transit. In one embodiment, the program calculates a single transit time boundary based on the total transit time for the two different travel modes. The program may also include such other time-based information as non-transit delay.

In one embodiment, the method includes accessing digital mapping service 66 and other internet based applications and servers through application program interface (API) 92 on user's device 50, as shown in the block diagram in FIG. 2. Alternatively, the API of digital mapping service 66 is accessible on internet 52 so transit-time map creating program 42 can automatically access digital mapping service 66 through the API.

In one embodiment, the program provides transit-time map boundary 30 using an average speed of travel or a typical speed of travel from user-defined initial location 26. The typical speed or average speed may depend on the type of road and on average or typical speeds on that road. It may take into account differences in speed that may arise from traffic, weather, time of day, or road conditions.

In another embodiment, the program provides the boundary using speed of travel as determined by transit-time map creating program 42 and by the mapping service 66 for a particular moment or moments in time, such as in substantially real time, taking into account actual speed on a particular road, as reported from meters or sensors or GPS devices, and relayed through the internet.

In one embodiment, the program provides the calculated transit time boundary extending 360 degrees around the user-defined location. In some cases, however, travel may not be available using the selected mode of travel in certain directions, such as because of geographical features, road conditions or the absence of roads in one direction or in certain areas, as shown in FIG. 1. Thus, transit-time map 20 may not have transit-time map boundary 30 extending in such directions.

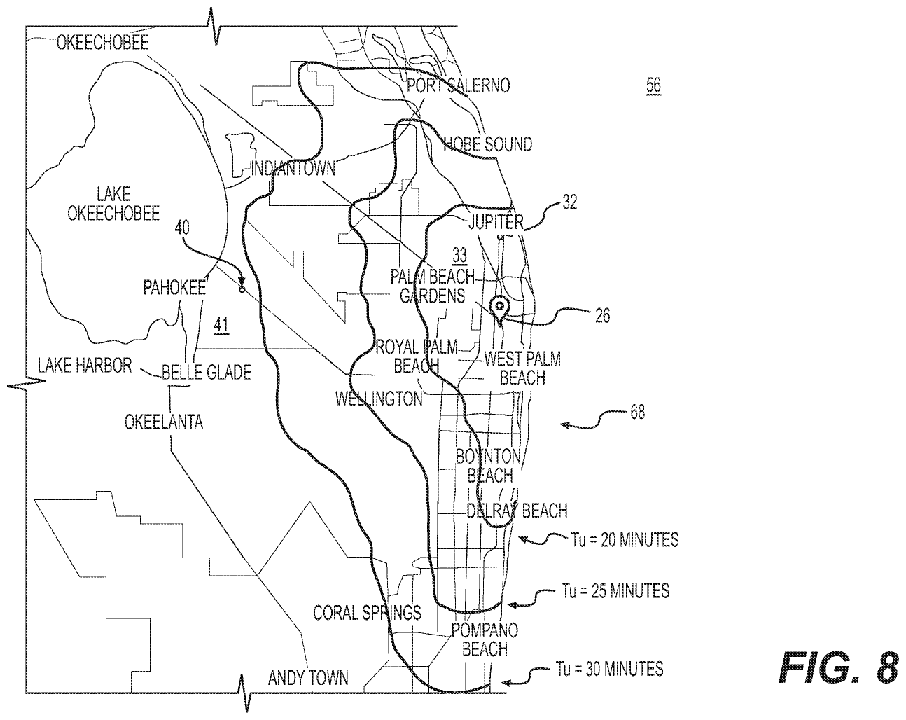

In one embodiment, the program provides several calculated transit time boundaries, as shown in FIG. 8, for several user-defined transit times Tᵤ.

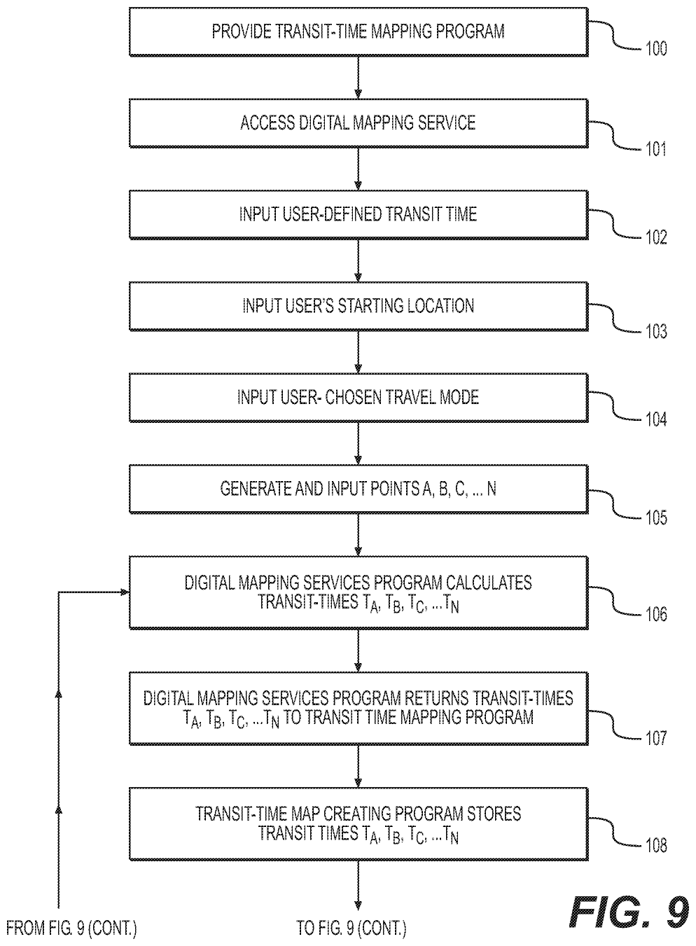

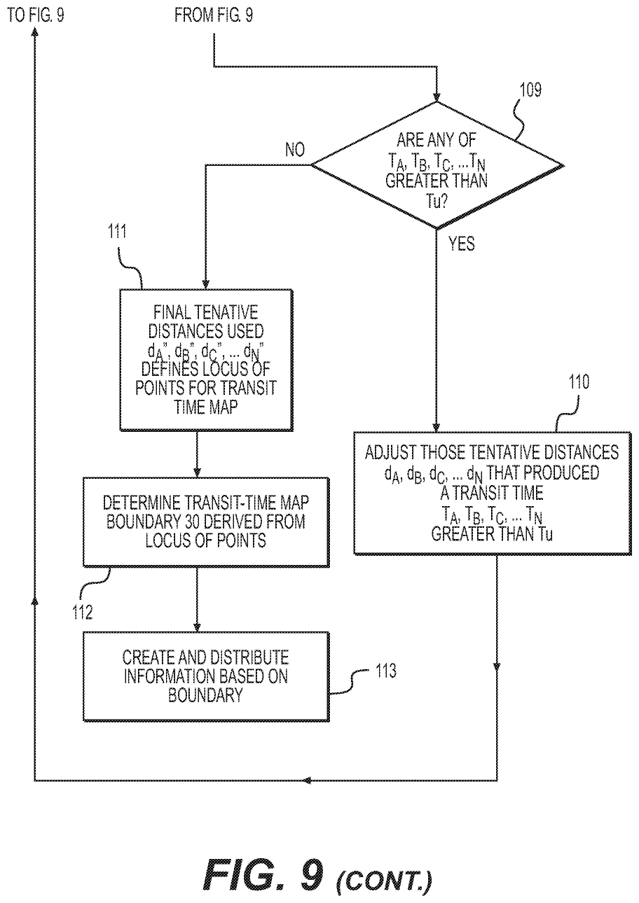

One embodiment of the method includes providing transit-time map creating program 42, as shown in box 100 of the flow chart in FIG. 9. Next, transit-time map creating program 42 accesses digital mapping service 66, as shown in box 101, inputting user-defined transit time Tᵤ, as shown in box 102, inputting user's starting location 26, as shown in box 103, and inputting user-chosen travel mode 28, as shown in box 104. Plurality of initially selected points A, B, C, . . . N, each along a different direction α, β, γ, . . . ξ from user-defined location 26 are generated, as further described herein below. Coordinates of points A, B, C, . . . N are input into digital mapping service 66, as shown in box 105.

Using these items of information, digital mapping service 66 calculates transit times T_{A}, T_{B}, T_{C}, . . . T_{N} from user-defined initial location 26 to each of plurality of points A, B, C, . . . N using user-chosen travel mode 28, as shown in box 106. Digital mapping service 66 then returns its calculated transit times T_{A}, T_{B}, T_{C}, . . . T_{N} to transit-time map creating program 42, as shown in box 107.

Times of travel T_{A}, T_{B}, T_{C}, . . . T_{N} from user-defined initial location 26 to each of plurality of points A, B, C, . . . N, as determined by digital mapping service program 66, are then recorded by transit-time map creating program 42, as shown in box 108.

Next, under transit-time map creating program 42, user-defined transit time Tᵤ is compared with recorded times of travel T_{A}, T_{B}, T_{C}, . . . T_{N} from the user-defined location 26 to plurality of points A, B, C, . . . N at plurality of tentative distances d_{A}, d_{B}, d_{C}, . . . d_{N} along the plurality of directions α, β, γ, . . . ξ, as shown in diamond box 109. The comparison answers the question, “Do any of the computed transit times T_{A}, T_{B}, T_{C}, . . . T_{N} in any of the directions α, β, γ, . . . ξ differ from the user-defined transit time Tᵤ by an amount δ that is greater than a pre-specified amount Δ?”

If the answer in diamond box 109 is “yes” for particular directions among plurality of directions α, β, γ, . . . ξ transit-time map creating program 42 adjusts tentative distances of those points A, B, C . . . N for which the answer is yes, as shown in box 110.

In one embodiment, the adjusting of the tentative distances of box 110 includes operating on the tentative distance with an algorithm that multiplies or divides the tentative distance by T_{N}/Tᵤ to provide adjusted points A′, B′, C′ . . . N′ at adjusted distances d_{A′}, d_{B′}, d_{C′}, . . . d_{N′} from user-defined initial location 26.

In another embodiment, the adjusting the tentative distance of box 110 includes operating on the tentative distance user-defined initial location 26 with a binary algorithm, such as adjusting the tentative distance by half of the previously determined tentative distance.

Transit-time map creating program 42 then returns to boxes 106 using newly adjusted distances points A′, B′, C′ . . . N′ at distances d_{A′}, d_{B′}, d_{C′}, . . . d_{N′}, from user-defined location 26 for recalculating transit times T_{A′}, T_{B′}, T_{C′}, . . . T_{N′} to reach points A′, B′, C′ . . . N′. The calculating, returning, recording, comparing, questioning, and adjusting steps in boxes 106, 107, 108, 109, and 110 are repeated for all N directions until the answer in decision diamond box 109 is “no” for all directions α, β, γ, . . . ξ.

If the answer in decision diamond box 109 is “no” for all directions α, β, γ, . . . ξ, a final computed transit time T_{A″}, T_{B″}, T_{C″}, . . . T_{N″} is obtained for each of the directions. Each of T_{A″}, T_{B″}, T_{C″}, . . . T_{N″} differs from user-defined transit time Tᵤ by an amount δ that is less than a pre-specified amount Δ. The final tentative distances d_{A″}, d_{B″}, d_{C″}, . . . d_{N″} from user-defined location 26 for each of plurality of directions α, β, γ, . . . ξ, defines points A″, B″, C″ . . . N″ or points 31 of locus of points 22, as shown in box 111.

In the next step transit-time map creating program 42 derives boundary 30 from points 31 of locus of points 22 as shown in box 112. In one embodiment, transit-time map creating program 42 derives boundary 30 by simply connecting points 31 of locus of points 22, as shown in FIG. 1c. In another embodiment, transit-time map creating program 42 adjusts boundary 30 to include an aspect of another source, such as postal zip codes through which locus of points 22 extend, as shown in FIG. 5b. The aspect may be an inner or outer boundary of each postal zip code or it may run along an intermediate between the inner and outer boundary.

Finally, transit-time map creating program 42 distributes information to devices based on their locations with respect to boundary 30, as shown in box 113. In one embodiment, transit-time map creating program 42 distributes information to devices within boundary 30 and avoids distributing information to devices outside boundary 30.

The calculations in box 106 performed by digital mapping service 66 for plurality of initial points A, B, C, . . . N, may be sequential or in parallel. For example, if sequential, point A at initial tentative distance d_{A} from user-defined location 26 along direction α is input into digital mapping service 66, which calculates time T_{A} to reach point A from user-defined location 26. Then point B at initial tentative distance d_{B} from user-defined initial location 26 along direction 13 is input into digital mapping service 66, which calculates time T_{B} to reach point B from user-defined location 26. The calculations continue for remaining points C, D . . . N.

If digital mapping service 66 is capable of operating on multiple requests in parallel, plurality of points A, B, C, . . . N are submitted to digital mapping service 66 in parallel, and digital mapping service 66 calculates transit times T_{A}, T_{B}, T_{C}, . . . T_{N} from user-defined initial location 26 to each of plurality of points A, B, C, . . . N using user-chosen travel mode 28 at the same time.

The number of points A, B, C, . . . N and the directions selected α, β, γ, . . . ξ may be adjusted by factors such as the number of roads available for travel from user-defined location 26. Initial distances d_{A}, d_{B}, d_{C}, . . . d_{N} may be adjusted in each direction α, β, γ, . . . ξ so each initial point A, B, C, . . . N, is located on or adjacent a road or path.

In one embodiment, the method of transit-time map creating program 42 starts with a circle on a map centered on the user-defined location. The circle has a tentative radius R, so in this embodiment all initial tentative distances d_{A}, d_{B}, d_{C}, . . . d_{N} in all directions α, β, γ, . . . ξ are equal to R.

In another example, the initial tentative distances varies according to road type: for travel along a road with higher speed limit a point at a larger initial tentative distance is used than for a road with a lower speed limit.

Once locus of points 22 is determined, as shown in box 111, transit-time map boundary 30 is determined, as shown in box 112. Transit-time map boundary 30 is determined by joining points 30 of locus of points 22 or by combining locus of points 22 with another source, such as postal codes.

Transit-time map boundary 30 is then used to distribute information based on boundary 30, as shown in box 113.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

What is claimed is:

1. A method of using a digital mapping service to produce a transit-time map, wherein the digital mapping service provides as an output a digital spatial map and a time to travel between pre-selected points on the digital spatial map for a specified travel mode, comprising the steps of:
a. providing a connected digital device;
b. providing a digital transit-time mapping program and inputting a user-defined initial location, a pre-defined transit-time, and a user-chosen travel mode into said digital transit-time mapping program;
c. running said digital transit-time mapping program, wherein said running said digital transit-time mapping program includes repeatedly accessing the digital mapping service to determine a locus of points on the digital spatial map, wherein said time to travel from the user-defined initial location to each point of said locus of points is substantially equal to said pre-defined transit time for the first user-chosen travel mode; and
d. storing said points of said locus of points on the digital spatial map.

2. A method as recited in claim 1, wherein said pre-defined transit time is user-defined.

3. A method as recited in claim 1, wherein said pre-defined transit time is program-defined.

4. A method as recited in claim 1, wherein said user-defined initial location is determined from a GPS receiver on said connected digital device.

5. A method as recited in claim 1, further comprising deriving a boundary on said digital spatial map from said locus of points.

6. A method as recited in claim 5, further comprising identifying an entity located within said boundary and audibly announcing a feature of said entity.

7. A method as recited in claim 5, further comprising identifying an entity located within said boundary and displaying a feature of said entity.

8. A method as recited in claim 5, further comprising displaying said digital spatial map and said boundary on said digital spatial map on a display.

9. A method as recited in claim 5, wherein said deriving a boundary is by connecting said points of said locus of points.

10. A method as recited in claim 5, wherein said deriving a boundary is from connecting points of a plurality of previously defined areas through which said locus of points extends.

11. A method as recited in claim 10, wherein said previously defined area includes one from the group consisting of a postal code area, a political district area, and a school district area.

12. A method as recited in claim 5, wherein said boundary on said digital spatial map has a first side and a second side, further comprising communicating information to a plurality of digital devices physically located on said first side while avoiding communicating said information to a plurality of digital devices physically located on said second side.

13. A method as recited in claim 12, wherein said information includes at least one from the group consisting of text, image, video, audio, and fax.

14. A method as recited in claim 5, further comprising searching for an entity within said boundary.

15. A method as recited in claim 14, further comprising looking up a parameter of the entity on a website of the entity.

16. A method as recited in claim 15, wherein said parameter includes at least one from the group consisting of a fact about the entity, a rating of the entity, and a non-travel-related delay time for receiving service at the entity.

17. A method as recited in claim 16, wherein said non-travel related delay time for receiving service at the entity includes at least one from the group consisting of hours the entity is open, an availability time during hours the entity is open, and a time for performing the service at the entity.

18. A method as recited in claim 1, wherein said digital transit-time mapping program is included in said digital mapping service.

19. A method as recited in claim 1, wherein said digital transit-time mapping program accesses the digital mapping service through an application program interface (API).

20. A method as recited in claim 19, wherein said digital mapping service is publically accessible on the internet, and further comprising accessing said digital mapping service through the internet.

21. A method as recited in claim 1, wherein said travel mode includes at least one from the group consisting of walking, biking, automobile, public transit, air travel, drone travel, elevator travel, and sub-ground level travel.

22. A method as recited in claim 1, further comprising a second user-chosen travel mode wherein said second user-chosen travel mode follows said user-chosen travel mode, wherein said calculating said locus of points includes both said time to travel for said user-chosen travel mode and time to travel for said second travel mode.

23. A method as recited in claim 1, wherein in said digital mapping service, a speed used for calculating said time to travel is an average speed or a typical speed.

24. A method as recited in claim 1, wherein in said digital mapping service, a speed used for calculating time to travel is an actual speed as measured in real time.

25. A method as recited in claim 1, wherein said locus of points extends 360 degrees around said user-defined location.

26. A method as recited in claim 1, wherein said repeatedly accessing the digital mapping service to determine said locus of points includes:
a. providing a plurality of points in a plurality of directions from the user-defined location, wherein each of the plurality of points has a tentative distance from the user-defined location;
b. recording time to travel from the user-defined location to the tentative distance along each of the plurality of directions, as computed by the digital mapping service program;
c. comparing the user-defined transit time with the computed time to travel for each of the plurality of directions;
d. if the computed time to travel in one of the directions is different from the user-defined transit time by an amount that is greater than a pre-specified amount, adjusting the tentative distance along that direction and repeating computing time to travel from the user-defined location to the now-adjusted tentative distance along that direction; and
e. repeating the comparing, computing, recording, and adjusting steps for the plurality of directions until the recorded time to travel in each of the directions is within the pre-specified amount of the user-defined transit time, wherein the tentative distance so obtained for each of the plurality of directions defines the locus of points.

27. A method as recited in claim 26, wherein said adjusting of the tentative distance in a direction includes operating on the tentative distance with an algorithm that increases or decreases the tentative distance.

28. A method as recited in claim 27, wherein said algorithm increases or decreases the tentative distance proportional to the ratio of the calculated transit time to the user-defined transit time.

29. A method as recited in claim 27, wherein at each said repeated access of the digital mapping service said algorithm adjusts the tentative distance by an amount equal to half the previous adjustment.
